(19) United States
(12) Patent Application Publication
(10) Pub. No.: US 2007/0124683 A1
(43) Pub. Date: May 31, 2007

(54) Method and system for providing visual information by means of the data network in real estate agency

(76) Inventors: Mikko Ranin, Espoo (FI); Jussi Nurmio, Helsinki (FI); Esa Rauhala, Helsinki (FI)

Correspondence Address: YOUNG & THOMPSON, 745 SOUTH 23RD STREET, 2ND FLOOR, ARLINGTON, VA, 22202, US

(21) Appl. No.: 11/592,246

(22) Filed: Nov. 3, 2006

(30) Foreign Application Priority Data
Nov. 4, 2005 (FI) 20051119

(51) Int. Cl. G01C 21/32

(52) U.S. Cl. 715/733; 701/208

(57) ABSTRACT

The invention relates to a method and a system for providing visual information by means of the data network in real estate agency for offering to potential buyers looking for a suitable object an opportunity to get an idea of the views in the environment of the object on sale. The method and the system according to the invention show the location area of the object on sale as a map image, at least one outlook point in the environment of the object on sale in the map image, and the outlook image representing the view, which can be seen by the virtual viewer placed in the corresponding position of the location area of the object on sale, corresponding to the outlook point, as a response to the indication of the outlook point in the map image.

### FIELD OF THE INVENTION

The invention relates to a method and a system for providing visual information by means of the data network in real estate agency, so that any potential buyer looking for a suitable object is given an opportunity to take a view of the environment of the object that is being sold.

### BACKGROUND OF THE INVENTION

Conventional instruments for matching potential buyers and sellers on the real estate and housing market include newspaper advertisements, advertisements published in a data network, such as the Internet, and presentation events arranged by the person selling the real estate or dwelling, or his or her agent. On the present real estate and housing market, there are a lot of objects on sale at the same time in growth centres, in particular. A potential buyer looking for a suitable object must screen the objects in advance on the basis of the information contained in the newspaper advertisements and those published in the data network to reduce the number of visits to the presentations, which require time and money.

The present data network technology, such as the Internet, can be used to implement sales advertisements that display the objects on sale, containing a good deal of visual and text information. For example, visual information may comprise several images and/or so-called slide images that present a given object on sale from different angles of view; a person examining the advertisement on their display terminals being able to turn the view angles by means of the controls on the user interface.

A potential buyer looking for a suitable object has a need to take a general impression not only of the object on sale but also of the environment of the object in question. On the basis of this general impression, the potential buyer can make a decision to possibly visit a presentation. Sales advertisements transferred through the data network, which are based on methods according to the known technology, can show map images, the window spaces of which can be enlarged, reduced and/or transferred by means of the user interface controls. By means of these map images, it is possible to gain information about the environment, where the object on sale is located. However, as the possibilities to gain environmental information by means of the known technology are limited, the potential buyer using the methods and systems according to the known technology must generally visit the physical environment of the object on sale.

### SUMMARY OF THE INVENTION

The purpose of the invention is to provide a new method for implementing a sales advertisement transferred through the data network so that a person examining the said sales advertisement can take a view of the environment of a given object on sale at different view angles, when they so desire. Another object of the invention is a system for implementing the sales advertisement transferred through the data network. A further object is a computer program for implementing the sales advertisement transferred through the data network.

The invention is based on combining the information that is displayed by means of the map images and the images showing the appearance. The images showing the appearance herein refer to images, which try to show how the building, the landscape or another object looks when viewed as if standing in the vicinity of the object in question. The image showing the appearance can be a photograph, drawing, painting, a picture made by computer graphics or the like, which is shown by the display terminal. The map image shows the location area of the object on sale so that, by means of the same, it is possible to take a view of the mutual positioning of the buildings, roads and other entities in the area. The map image can be, for example, a drawing shown on the display terminal or a photograph showing a top view of the area under examination. In the method according to the invention, the map image shows points, to which the person examining the sales advertisement can point to open a picture that shows the outlook and the appearance from the said point.

A method according to the invention for providing visual information by means of a data network in real estate agency is characterized in that in the method comprises:
a location area of an object on sale is presented as a map image,
at least one outlook point in an environment of the object on sale is presented in said map image,
an indication of said outlook point in said map image is observed,
as a response to the indication of said outlook point in said map image a memory address is identified and an outlook image representing a view that can be seen by a virtual viewer placed in a point of the location area of the object on sale is retrieved from a location of an outlook data base referred to by the memory address, said point of the location area of the object on sale corresponding to said outlook point, and
said outlook image is displayed.

A system according to the invention for providing visual information by means of a data network in real estate agency is characterized in the system comprises:
a map data base for storing a map image of a location area of an object on sale,
a map display for showing the map image of the location area of the object on sale and at least one outlook point in an environment of the object on sale,
an outlook data base for storing an outlook image representing a view that can be seen by a virtual viewer placed in a point of the location area of the object on sale, said point of the location area of the object on sale corresponding to said outlook point,
an outlook display for displaying said outlook image, and
a control unit for observing an indication of said outlook point in said map image, for identifying a memory address of the outlook data base referring to said outlook image, for retrieving said outlook image from said outlook data base from a location indicated by said memory address, and for controlling said outlook display to display said outlook image as a response to the indication of said outlook point in said map image.

A computer program according to the invention stored in a processor readable means for providing visual information by means of a data network in real estate agency is characterized in that the computer program comprises:
programmatic means for displaying a location area of an object on sale as a map image,
programmatic means for displaying at least one outlook point in an environment of the object on sale in said map image,
programmatic means for observing an indication of said outlook point in said map image,
programmatic means for identifying a memory address corresponding to said outlook point and for retrieving an outlook image from a place indicated by said memory address from an outlook data base as a response to the indication of said outlook point in said map image, said outlook image representing a view that can be seen by a virtual viewer placed in a point of the location area of the object on sale corresponding to said outlook point, and
programmatic means for displaying said outlook image.

The various embodiments of the invention are characterized in that which is presented in the dependent claims.

The invention provides the considerable advantage that the sales advertisements implemented by the method and the system according to the invention provide a general impression of the environments of the objects on sale to the potential buyer looking for a suitable object, whereby the need for visits that require time and money is reduced.

The exemplary embodiments of the invention presented in this document are not to be interpreted to pose limitations to the applicability of the appended claims. The verb “to comprise” is used in this document as an open limitation that does not exclude the existence of also unrecited features. The features recited in depending claims are mutually freely combinable unless otherwise explicitly stated.

### SHORT DESCRIPTION OF THE DRAWINGS

In the following, the invention is described in detail with reference to the preferred embodiments, shown as examples, and the appended drawings, in which:

FIGS. 1a and 1b show examples of the visual information produced by the sales advertisement implemented by the method according to an embodiment of the invention,

FIGS. 2a and 2b show examples of the visual information produced by the sales advertisement implemented by the methods according to some embodiments of the invention,

FIG. 3 shows a flow chart of the method according to one embodiment of the invention for providing visual information by means of the data network in real estate agency,

FIG. 4 shows a system according to an embodiment of the invention for providing visual information by means of the data network in real estate agency,

FIG. 5 shows equipment, which can be used to implement the system according to an embodiment of the invention for providing visual information by means of the data network in real estate agency.

### DETAILED DESCRIPTION OF THE EMBODIMENTS OF THE INVENTION

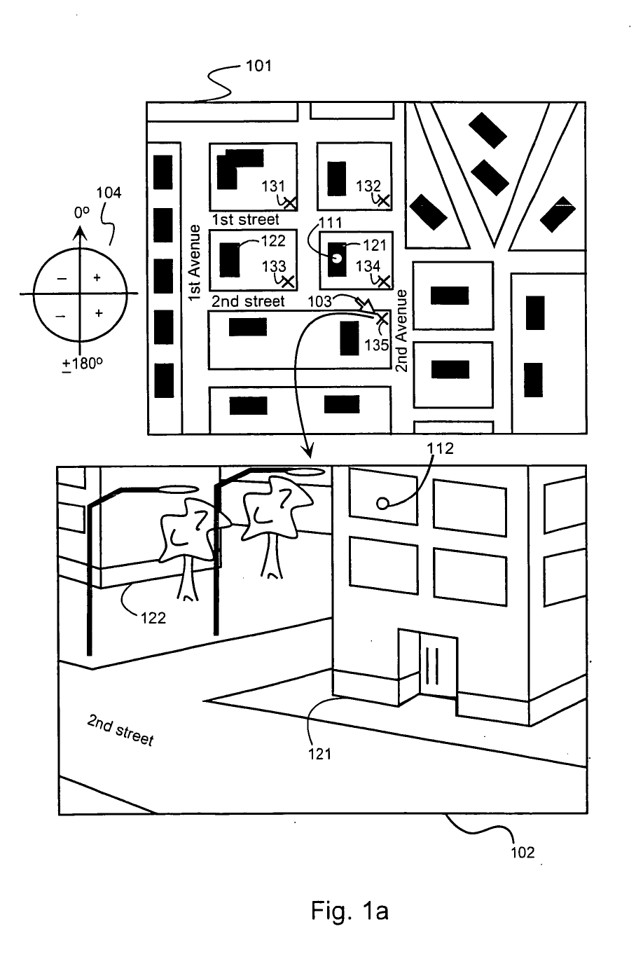

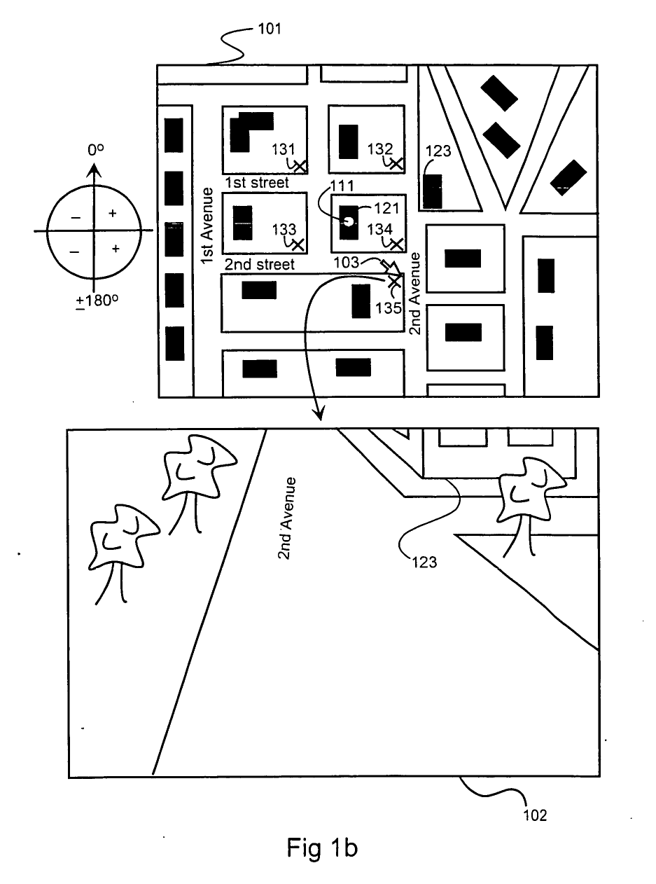

FIG. 1a shows an example of the visual information produced by a sales advertisement implemented by the method according to an embodiment of the invention. The upper image window presents a map image 101 that shows the location area of the object on sale. The map image 101 shows the streets and the buildings in the area. The buildings are presented as black figures. The position in the map image 101, corresponding to the location of the object on sale, is indicated by localization data, which in this embodiment of the invention is a white circle 111 marked in the map image. The location of the object on sale in the map image can be expressed in various ways. For example, the localization data can be presented as coordinate values, which are connected with the coordinate system laid in the map image. In this example of a situation, the object on sale is a flat located in building 121. The ticks 131-135 in the map image are points, by which the view that can be seen is shown in a separate image window. In this document, the points are called outlook points.

In the method according to this embodiment of the invention, one outlook point 131 -135 can be used to open a view in each direction 45, −45, 135, and −135 degrees, indicated by a branch of the tick, wherein the said degrees are defined by means of a directional circle 104. The lower image window shows an image 102 presenting the appearance and showing a view, which a virtual viewer placed in the outlook point 135 sees when looking in the direction of −45 degrees. The virtual viewer is an imaginary person, who is placed in a position corresponding to the outlook point in the real location area of the object on sale. The image 102 that presents the said view is herein called an outlook image and the said direction is called an outlook direction. In this example of a situation, the outlook image shows buildings 121 and 122, among others. The window of the flat that is being sold in this example of a situation is shown in the outlook image 102. The said window is indicated by localization data, which in this embodiment of the invention is the white circle 112 that is marked in the outlook image. The location of the object on sale or its part in the outlook image can be expressed in various ways. For example, the said localization data can be presented as coordinate values that are connected with the coordinate system laid in the outlook image. For example, the disclosure of the outlook points 131-135 can be implemented so that a cursor 103 is pointed to the branch of the tick representing the outlook point, in the outlook direction indicated by which a view is to be opened. Another alternative is to connect to each outlook point an individual identification code, such as an identification number, combination of identification letters or the coordinates of the outlook point. In that case, a certain outlook point can be indicated by giving the command line or some other entry area, which is offered by the user interface, the identification code of the said outlook point. The outlook direction can also be rendered to be given to the command line or other entry area. One alternative is a menu, which can be used to select the desired outlook point individualized by the identification code, and the desired outlook direction connected with the said outlook point.

FIG. 1b shows a situation, in which the outlook point 135 is indicated so that the outlook direction is 45 degrees. In that case, the outlook image 102 displays the building 123 that is marked in the map image 101, among others. In this case, the object on sale is not even partially visible in the outlook image 102.

For clarity's sake, FIGS. 1a and 1b show the map image and the outlook image in separate image windows, which are not even partially superimposed. In the method and the system according to the invention, the map image and the outlook image can also be displayed in the same image window so that the outlook image either totally or partially covers the map image, or the map image totally or partially covers the outlook image, depending on which image the user would like to watch at the time. The map and outlook images displayed in separate image windows can also entirely or partially cover one another.

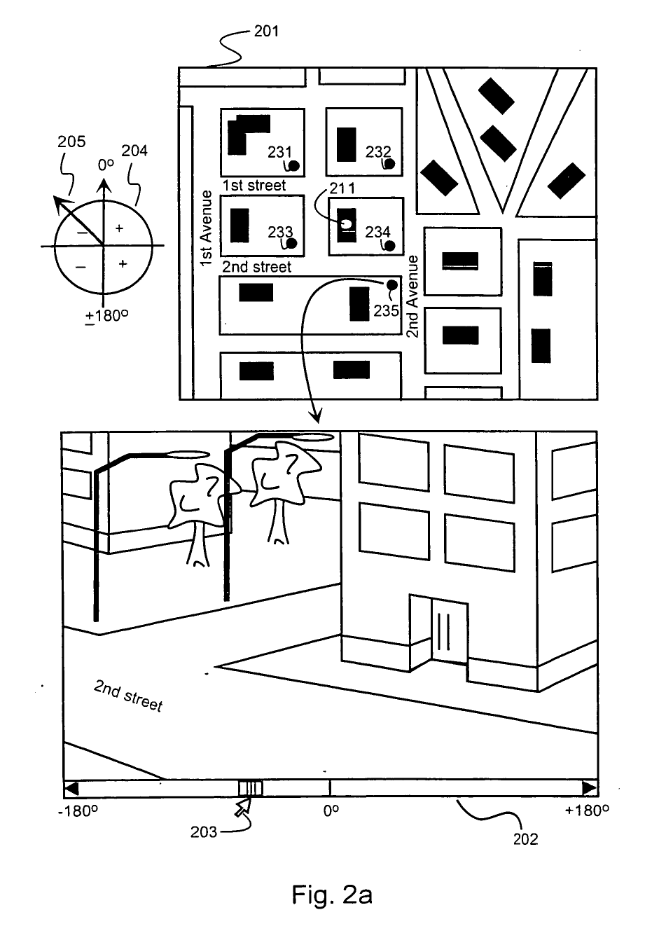

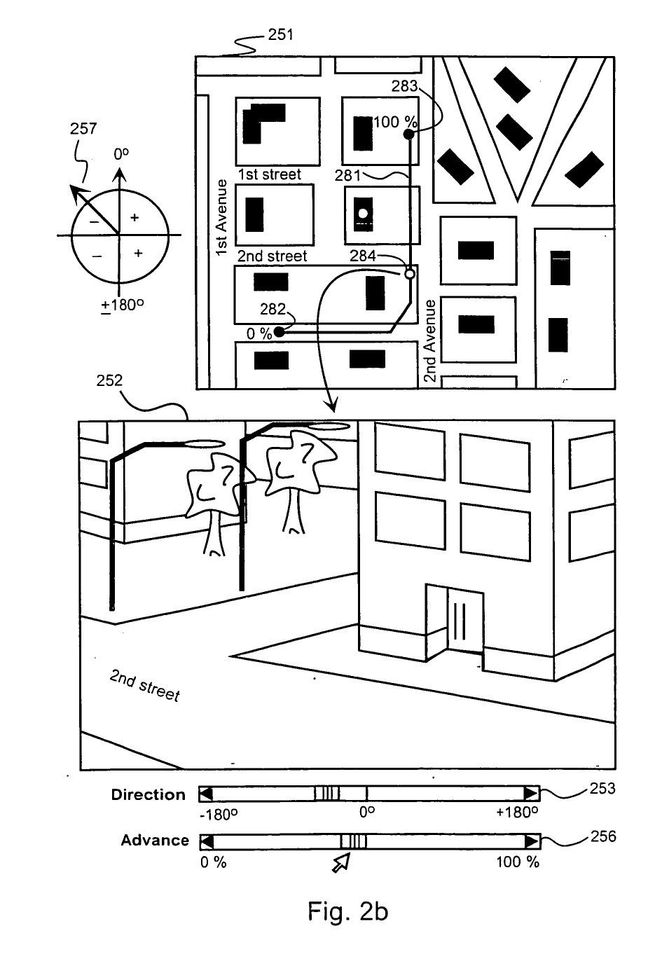

FIG. 2a shows an example of the visual information produced by a sales advertisement implemented by the method according to an embodiment of the invention. The position corresponding to the location of the object on sale in the map image 201 is indicated by localization data, which in this embodiment of the invention is the white circle 211 marked in the map image. The location of the object on sale in the map image can be expressed in various ways. For example, the localization data can be presented as coordinate values, which are connected with the coordinate system laid in the map image. The black circles 231-235 in the map image 201 represent the outlook points. In this embodiment, the outlook direction related to the respective outlook point can be selected from a range of −180 . . . 180 degrees. The outlook image 202 corresponds to the outlook point 235 and the outlook direction of about −40 degrees. In this embodiment, the determination of the outlook direction is implemented so that, in the lower part of the outlook image 202, there is a scroll bar 203 for controlling the outlook direction. To illustrate the presentation, there is an indicator 205 in the directional circle 204, pointing to the outlook direction prevailing at the time. Other alternatives for giving the outlook direction include an arrangement, wherein the degree, which represents the outlook direction, or some other angle information is given to the command line or other entry area provided by the user interface, and an arrangement, wherein a cursor can be used to turn the indicator 205 to provide the desired outlook direction. The outlook direction of the outlook image 202 to be presented can change stepwise, even if the outlook direction given by means of the user interface were changed evenly at the constant-angular velocity. In that case, only the outlook images that correspond to certain discrete, preselected outlook directions are thus presented. If the desired outlook direction is between two preselected outlook directions, the outlook image corresponding to the preselected outlook direction that represents a larger angular value can be displayed, for example. The outlook direction can also be implemented so as to change steplessly, so that the images, which are needed between the outlook images representing adjacent outlook directions, are formed by interpolation on the basis of the said outlook images, using the image processing methods according to the known technology.

FIG. 2b shows an example of the visual information produced by a sales advertisement implemented by the method according to an embodiment of the invention. The line 281 shown in the map image 251 is a track of outlook points, consisting of subsequent outlook points. In the method according to this embodiment of the invention, the position 284 of the virtual viewer on the track 281 of outlook points is controlled by a scroll bar 256, which can be used to set the relative advance of the virtual viewer from the beginning 282 of the track of outlook points, compared with the total length of the track outlook points from the beginning 282 to its tail 283. Except for the beginning and the tail, no separate outlook points are shown in the map image 251. The outlook direction is controlled by a scroll bar 253. Other alternatives for defining the position of the virtual viewer include an arrangement, wherein the percentage indicating the position 284 of the virtual viewer or some other parameter is given to the command line or the other entry area provided by the user interface, and an arrangement, wherein the cursor can be used to indicate and move the position 284 of the virtual viewer shown in the map image. The outlook image that is shown changes, when the position 284 of the virtual viewer advances on the track 281 of outlook points. The outlook image 252 that is presented can change stepwise, even if the position 284 of the virtual viewer advanced evenly at a constant speed on the track 281 of outlook points. In that case, only the outlook images corresponding to the outlook points on the track are shown. If the position 284 of the virtual viewer is between two outlook points, for example, the outlook image corresponding to the outlook point can be presented, which is further away from the beginning 282 of the track of outlook points. The outlook can also be implemented to change steplessly by interpolating the images, which are needed between subsequent outlook images, on the basis of the said outlook images, using the image processing methods according to the known technology. The direction of view of the virtual viewer is illustrated by an indicator 257. In the method according to this embodiment, indication of the outlook point means that the virtual viewer has been placed in a position corresponding to the outlook point under examination. Individual outlook points may be located on the track 281 of outlook points at either equal or unequal intervals. In a theoretical extreme case, the track of outlook points becomes a continuum, when the number of outlook points on the track of outlook points grows without limits and even the greatest distance between two adjacent outlook points approaches zero. Also in this theoretically extreme case, the situation can be examined by means of single outlook points. In the method according to this embodiment of the invention, it is not necessary to show a symbol or some other picture element in the map image 251, indicating the position of the virtual viewer, as the position of the virtual viewer is fully defined on the basis of the relative advance described above, for example.

In the method according to one embodiment of the invention, the person considering the sales advertisement can define the time, during which the virtual viewer advances from the beginning 282 of the track of outlook points to its end 283, or from the end to the beginning. In that case, a virtual promenade in the location area of the object on sale can be offered to the person considering the sales advertisement. The track of outlook points can also be a closed curve, whereby the beginning and the end meet.

In the method according to one embodiment of the invention, the person examining the sales advertisement can define the outlook direction as a function of the position of the virtual viewer. For example, the outlook direction can be given in the form of a table so that certain values of the outlook direction correspond to certain positional values. The values of the outlook direction that remain in between the table values can be formed by means of a linear interpolation, for example.

In the method according to one embodiment of the invention, the person examining the sales advertisement can select from the following alternatives the season, of which they want to see the views: spring, summer, autumn and winter.

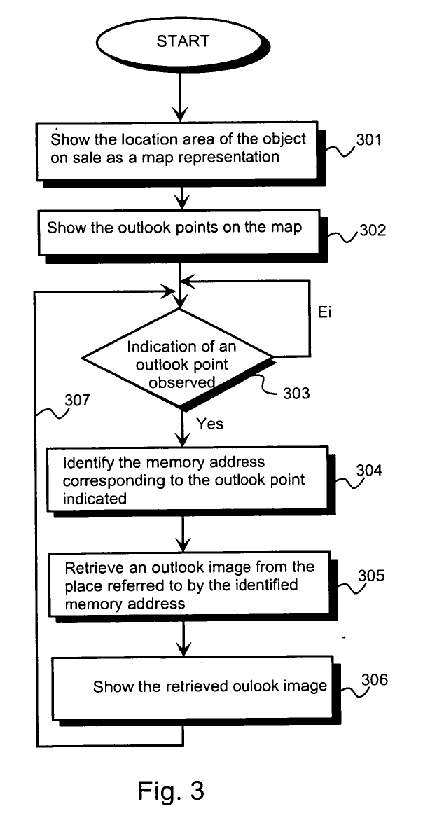

FIG. 3 shows a flow chart of the method according to one embodiment of the invention for providing visual information by means of the data network in real estate agency. At stage 301, the location area of the object on sale is shown as a map representation. At stage 302, one or more outlook points or one or more tracks formed by at least two subsequent outlook points are presented in the said map representation. In the decision block 303, one can check, whether any of the outlook points mentioned has been indicated. If there is no observation on indicating an outlook point, the situation is rechecked within a certain time, whereby we are talking about a polling method, or a wait state is assumed, which one can exit, when any outlook point is indicated, whereby we are talking about a triggering method. If there is an observation on indicating an outlook point, the memory address corresponding to the outlook point indicated is identified at stage 304. Only one memory address can correspond to a single outlook point or several memory addresses can correspond to a single outlook point, one of them being selected on the basis of the outlook direction. On the basis of the memory address, an outlook image is retrieved at stage 305 from the outlook data base containing the outlook images and from the location referred to by the said memory address. The said outlook image is shown, for example, on the screen of a computer at stage 306. After the outlook image has began to be shown, one can stay and wait 307 for another indication of an outlook point. The outlook image is changed, when an outlook point, which is not the same as the one previously indicated, has been indicated, and when an outlook point, which is the same as the one previously indicated, has been indicated, but the outlook direction deviates from the outlook direction prevailing at the previous time. In other words, the outlook image is changed, when the memory address changes.

In the method according to one embodiment of the invention, the position corresponding to the location of the object on sale is disclosed in the map representation by means of localization data, which can be, for example, a symbol showing the location of the object on sale, which is marked in the map representation.

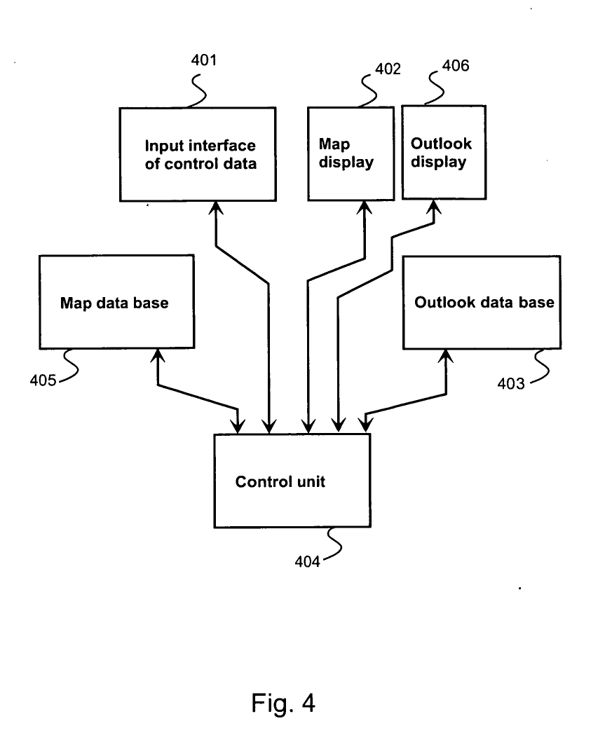

FIG. 4 shows the system according to one embodiment of the invention for providing visual information by means of the data network in real estate agency. The system includes an input interface 401 of control data, a map display 402, an outlook display 406, an outlook data base 403, a map data base 405, and a control unit 404. Through the input interface 401 of the control data, the person examining the sales advertisement can, for example, point to the outlook points, set the outlook direction, and define the settings associated with the virtual viewer advancing on the track of outlook points. The map and outlook displays 402 and 406 are used to show the map image and the outlook images. The outlook data base 403 contains the files that contain the information needed for forming the outlook images. The outlook images can be stored in files in the jpeg format, for example. The map data base 405 contains the files that contain the information needed for forming the map images and the outlook points shown on the map. The map images can be stored in files in the jpeg format, for example. The information needed for forming the outlook points can be stored as a coordinate representation in an alphanumeric form, for example. The control unit 404 controls the joint operation of the parts of the system described above. The control unit is used to implement the operations of the method according to one or more embodiments of the invention described above, such as the observation of indicating an outlook point, identification of the memory address corresponding to the outlook point, retrieving the outlook image from the outlook data base 403 from a location corresponding to the identified memory address, and controlling the outlook display to show the said outlook image.

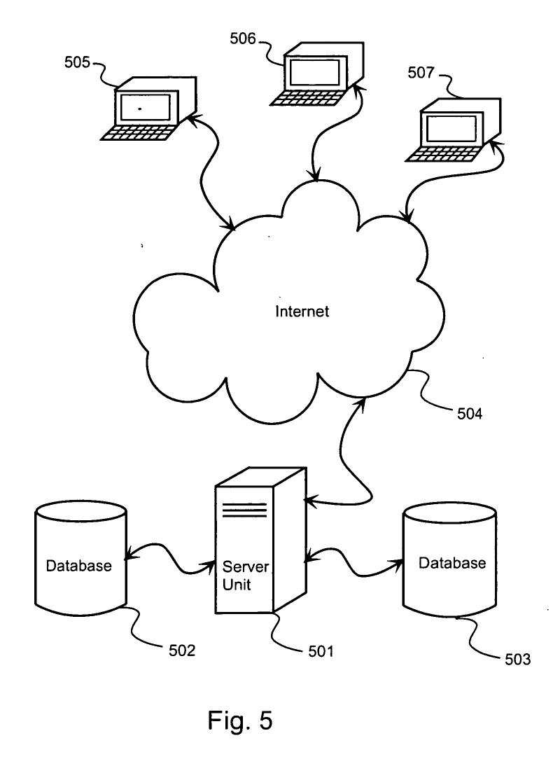

FIG. 5 shows equipment, which can be used to implement the system shown in FIG. 4 for providing visual information by means of the data network in real estate agency. The equipment comprises a server unit 501, which is used to implement the control unit 406 shown in FIG. 4. The input interface 401 of the control data, the map display 402 and the outlook display 406 are implemented by means of the server unit 501, the data network 504 and the user terminal device 505, 506 or 507 of the person considering the sales advertisement. The server unit 501 is used to administer the duplex data transfer to one or more memory units 502 and 503, which are used to implement the map data base 405 and the outlook data base 403. The memory units can be physically separate memory devices, such as separate hard disks, or they can be different sectors of the address space of one physical memory device. The server unit 501 is used to implement the data lines to the user terminal devices 505 to 507 through the data network 504, whereby the potential buyers and other quarters can, by means of these data lines, use the input interface of the control data and retrieve the map and outlook images on the screens of their terminal devices. The data network 504 can comprise the public Internet and the data lines in question can be implemented using the TCP/IP protocol.

In the system according to one embodiment of the invention, the map data base and/or the outlook data base are implemented in a distributed manner so that the map data base and/or the outlook data base are located in several physically separate memory units, which can even be located in different localities. In that case, the memory address indicating the outlook or map image, for example, consists of the Internet address of the terminal device connected to the memory unit under examination and a qualifying part, which points to the outlook or map image under examination in the said memory unit.

In the system according to one embodiment of the invention, the functions described in connection with the methods according to the embodiments of the invention described above are implemented by means of a computer program, and the information contained in its programmatic means, such as spatial machine structures and functions, can be read by one or more processors of the server unit 501, the programmatic means making the said one or more processors carry out the operations described above. The said computer program for providing visual information by means of the data network in real estate agency contains at least the following programmatic means:
programmatic means for presenting the location area of the object on sale as a map image,
programmatic means for presenting at least one outlook point in the environment of the object on sale in the said map image,
programmatic means for observing the indication of the said outlook point in the said map image,
programmatic means for identifying the memory address corresponding to the said outlook point and for retrieving the outlook image presenting the view, which can be seen by the virtual viewer placed in the position of the location area of the object on sale corresponding to the said outlook point, from the location indicated by the said memory address in the outlook data base as a response to the indication of the said outlook point in the said map image, and
programmatic means for showing the said outlook image.

In the system according to an alternative embodiment of the invention, part of the functions described above are implemented by using application-specific integrated circuits (ASIC) designed for a certain operation, and part of the operations described above are implemented by the programmatic means. One advantage of the application-specific integrated circuits is their higher rate of performance than that of the programmable processor.

As is obvious to those skilled in the art, the invention and its embodiments are not limited to the embodiment examples described above, but the invention and its embodiments can be varied within the independent claims.

What is claimed is:

1. A method for providing visual information by means of a data network in real estate agency, the method comprising:
a location area of an object on sale is presented as a map image,
at least one outlook point in an environment of the object on sale is presented in said map image,
an indication of said outlook point in said map image is observed,
as a response to the indication of said outlook point in said map image a memory address is identified and an outlook image representing a view that can be seen by a virtual viewer placed in a point of the location area of the object on sale is retrieved from a location of an outlook data base referred to by the memory address, said point of the location area of the object on sale corresponding to said outlook point, and
said outlook image is displayed.

2. A method according to claim 1, wherein an outlook direction is determined and said outlook image presents a view that can be seen by said virtual viewer in said outlook direction.

3. A method according to claim 1, wherein said map image is used to show a track of outlook points comprising at least two outlook points, which a first outlook image and a second outlook image correspond to, said first outlook image is shown, a position of said virtual viewer is moved along said track of outlook points, and the outlook image to be shown is changed from said first outlook image into said second outlook image as a response to a change in the position of said virtual viewer on said track of outlook points.

4. A method according to claim 3, wherein the position of said virtual viewer on said track of outlook points is moved from a first point of said track of outlook points to a second point of said track of outlook points in a predefined time.

5. A method according to claim 3, wherein an outlook direction is determined at least partly on the basis of the position of said virtual viewer on said track of outlook points, and the presented outlook image shows a view that can be seen by said virtual viewer in said outlook direction.

6. A method according to claim 1, wherein for said outlook image an outlook image corresponding to one of the following seasons is selected: spring, summer, autumn, and winter.

7. A method according to claim 1, wherein localization data is displayed, said localization data indicating a place corresponding to a location of the object on sale in said map image.

8. A system for providing visual information by means of a data network in real estate agency, the system comprising:
a map data base for storing a map image of a location area of an object on sale,
a map display for showing the map image of the location area of the object on sale and at least one outlook point in an environment of the object on sale,
an outlook data base for storing an outlook image representing a view that can be seen by a virtual viewer placed in a point of the location area of the object on sale, said point of the location area of the object on sale corresponding to said outlook point,
an outlook display for displaying said outlook image, and
a control unit for observing an indication of said outlook point in said map image, for identifying a memory address of the outlook data base referring to said outlook image, for retrieving said outlook image from said outlook data base from a location indicated by said memory address, and for controlling said outlook display to display said outlook image as a response to the indication of said outlook point in said map image.

9. A system according to claim 8, comprising an input interface of control data to determine an outlook direction, and said control unit is arranged to control said outlook display to show the outlook image that shows a view that can be seen by said virtual viewer in said outlook direction.

10. A system according to claim 9, wherein said control unit is arranged to control said map display to show in the map image a track of outlook points comprising at least two outlook points, which a first outlook image and a second outlook image correspond to, and to control said outlook display to show said first outlook image; said input interface of the control data comprises means for moving a position of said virtual viewer on said track of outlook points, and said control unit is arranged to change the outlook image, which is shown, from said first outlook image into said second outlook image as a response to a change in the position of said virtual viewer on said track of outlook points.

11. A system according to claim 10, wherein said control unit is arranged to move the position of said virtual viewer on said track of outlook points from a first point of said track of outlook points to a second point of said track of outlook points in a predefined time.

12. A system according to claim 10, wherein said control unit is arranged to at least partly determine an outlook direction on the basis of the position of said virtual viewer on said track of outlook points and to control said outlook display to show the outlook image that presents a view that can be seen by said virtual viewer in said outlook direction.

13. A system according to claim 8, wherein said input interface of the control data comprises means for commanding the outlook image to show a situation corresponding to one of the following seasons: spring, summer, autumn, and winter.

14. A system according to claim 8, comprising means for displaying localization data indicating the place corresponding to a location of the object on sale in said map image.

15. A computer program stored in a processor readable means for providing visual information by means of a data network in real estate agency, the computer program comprising:
programmatic means for displaying a location area of an object on sale as a map image,
programmatic means for displaying at least one outlook point in an environment of the object on sale in said map image,
programmatic means for observing an indication of said outlook point in said map image,
programmatic means for identifying a memory address corresponding to said outlook point and for retrieving an outlook image from a place indicated by said memory address from an outlook data base as a response to the indication of said outlook point in said map image, said outlook image representing a view that can be seen by a virtual viewer placed in a point of the location area of the object on sale corresponding to said outlook point, and
programmatic means for displaying said outlook image.
